(19) United States
(12) Patent Application Publication
(10) Pub. No.: US 2018/0232701 A1
(43) Pub. Date: Aug. 16, 2018

(54) METHOD AND COMPUTER PROGRAM PRODUCT FOR MAKING A FIT COMPARISON OF A CANDIDATE IN A GROUP

(71) Applicant: Capital H NV, Mechelen (BE)

(72) Inventors: Joeri Hofmans, Mechelen (BE); Jürgen Noël, Mechelen (BE); Arend Van Itterbeek, Mechelen (BE)

(21) Appl. No.: 15/444,903

(22) Filed: Feb. 28, 2017

(30) Foreign Application Priority Data
Feb. 13, 2017 (BE) BE2017/5089

(51) Int. Cl. G06Q 10/10; G09B 7/06

(52) U.S. Cl. CPC G06Q 10/1053; G09B 7/06

(57) ABSTRACT

The invention relates to a method and a computer program product for a fit comparison of a candidate in a group. A value test is provided on a computer having at least one screen and at least one input device. The value test includes a plurality of statements and a scoring system for associating a score with each statement. Each score has a numerical value. The value test is completed by the candidate and a plurality of reference persons. The numerical values of one or multiple scores of the candidate are compared quantitatively with the numerical values of one or multiple scores of the plurality of reference persons.

### TECHNICAL DOMAIN

The invention relates to a method and a computer program product for making a fit comparison of a candidate in a group. A value test is provided on a computer comprising at least one screen and at least one input device. The value test comprises a plurality of statements and a scoring system for associating a score with each statement. Each score comprises a numerical value. The value test is filled in by the candidate and a plurality of reference persons. The numerical values of one or multiple scores of the candidate are compared quantitatively with the numerical values of one or multiple scores of the plurality of reference persons.

### STATE OF THE ART

During a selection process for selecting a candidate for a position within an organisation, the candidate's relevant history, competencies and personality are assessed. The relevant history comprises, among other things, the candidate's education, diplomas and work experience. These aspects can be assessed by studying the candidate's curriculum vitae, motivation letter and the interview with the candidate. In addition, a personality questionnaire and competency tests can be completed by the candidate. In a team of employees, it is important to have a wide knowledge, competency and personality basis, so that the team is capable of solving a variety of problems.

In addition to the knowledge, the competencies and the personality of the candidate, the candidate's values are also important. These values comprise conceptual themes such as, for example, integrity, recognition for work delivered, the willingness to work together, and the peaceful resolution of problems. It is evident from the study by Hoffman and Woehr described in the Journal of Vocational Behaviour 68(3), 389-399 (2006); the study of Meyer, Hecht, Gill and Toplonytsky described in the Journal of Vocational Behaviour 76(3), 458-473 (2010); and the study by Kristof-Brown, Zimmerman and Johnson described in Personnel Psychology 58(2), 281-342 (2005) that a high degree of agreement in the values of employees within an organisation leads to greater long-term engagement, less employee turnover, greater productivity and greater job satisfaction, i.e. more successful recruitment.

In the assessment of a candidate's values during an interview with an interviewer, there are, however, a number of problems. If the interviewer is not an employee of the organisation, this person may not be familiar with the values and standards that prevail in the organisation. Moreover, an interviewer often assesses a candidate's values on the basis of social wishes, rather than the values prevailing in the organisation. Research has also shown that the interviewer is more likely to compare the values of the candidate with his or her own values rather than the values of the organisation. Moreover, this assessment is extremely subjective. The study by Kutcher, Bragger and Masco described in the International Journal of Selection and Assessment 21(3), 294-308 (2013) also shows that the response of a candidate depends on the attitude of the interviewer, e.g. whether the interviewer is open or closed, and also on the procedures used, e.g. whether the interview is conducted formally or informally. Consequently, there is a need for an objective comparison of the values of a candidate with the values of those who may be his or her future colleagues.

The Psychological Testing Centre (PTC) of the British Psychological Society keeps a list of existing psychometric tests. The PTC's list shows first of all that most of the psychometric tests are aimed at personality and competencies. Only a few psychometric tests deal with values, but these tests focus purely on the candidate and not on a comparison between the candidate and the organisation:
Hogan's Motives, Values, Preferences Inventory (MVPI) test of Psychological Consultancy Ltd also tests, as well as motivation and interests, the values of a candidate. The test is aimed only at the candidate. Moreover, the ten fixed dimensions of the model used may not always be as relevant for every organisation.
The Managerial and Professional Profiler (MAPP) of Knight Chapman Psychological Ltd also tests, as well as personality, motivations and cognitive style, for values. With the MAPP too, the candidate's value profile is only measured one-sidedly.
The Saville Consulting Wave searches for the preferred culture in a candidate. Here too, no comparison is made with the prevailing values of the organisation.

In the value tests described above, no comparison is made between the values of the candidate and those of the employees of the organisation. Consequently, these value tests do not provide technical means for quickly and easily obtaining the data needed of the candidate and the employees, nor do the value tests provide a technical solution for assessing this data quickly, easily, objectively and quantitatively.

The present invention aims to find a solution for at least some of the above-mentioned problems.

### SUMMARY OF THE INVENTION

In a first aspect, the present invention relates to a method for making a fit comparison of a candidate in a group, as described in claim 1.

In a second aspect, the present invention relates to a computer program product for making a fit comparison of a candidate in a group by taking a value test with the aid of a computer, such as described in claim 9.

The present invention is advantageous for various reasons.

A first advantage is the providing of an objective value test for associating scores with statements. Each statement preferably comprises a position on at least one value. A score may, for example, be a degree of agreement such as e.g. “strongly agree”, “neutral” or “partly disagree”; a colour; a number; or any measure whatsoever for assessing a statement. Because a numerical value corresponds to each score, it is possible to carry out an objective numerical analysis for the comparison of value tests. The value test can be completed both by the candidate and by the plurality of reference persons, e.g. employees of an organisation, in order to compare the value profile of the candidate and the organisation.

A second advantage is the providing of the value test on at least one computer. This allows the test to be taken simultaneously by various people. This also allows the test to be taken by a large number of people, e.g. by employees of an organisation on their own work computer.

A third advantage concerns the uniformity and the objectivity of the taking of the value test. The candidate or employees are not influenced by the behaviour of the interviewer or the methods used by the interviewer. Everyone takes the same test in the same way and in the same conditions.

A fourth advantage concerns the digital availability of the completed value test. Filling in on a computer ensures not only objectivity, uniformity and ease for the taking of the value test, but also ensures that the completed value test (or data based on the completed value test) is immediately digitally available for further processing.

### DESCRIPTION OF THE FIGURES

FIG. 1 is a schematic representation of an ipsative Q-sort.

FIGS. 2 and 3 comprise examples of graphs for displaying and assessing a candidate's value profile.

FIG. 4 comprises an example for displaying the value profile of a unit within an organisation.

### DETAILED DESCRIPTION

The invention relates to a method and a computer program product for making a fit comparison of a candidate in a group. A summary of the present invention is given in the section provided for this. The invention is described in detail below, and preferred embodiments as well as examples are given by way of illustration.

Unless otherwise defined, all the terms that are used in the description of the invention, also technical and scientific terms, have the meaning as they are generally understood by the skilled person in the technical field of the invention. For a better assessment of the description of the invention, the following terms are explained explicitly.

“A”, “an” and “the” refer in this document to both the singular and the plural, unless the context clearly presumes otherwise. For example, “a segment” means one or more than one segment.

The terms “comprise”, “comprising”, “consist of”, “consisting of”, “provided with”, “contain”, “containing”, “include”, “including”, “involve”, “involving” are synonyms and are inclusive or open terms that indicate the presence of what follows, and which do not exclude or preclude the presence of other components, characteristics, elements, members, steps, known from or described in the state of the art.

The term “computer” refers in this document to a device suitable for carrying out instructions on a processor. A non-limitative list of examples of computers comprises a desktop, a laptop, a smartphone, a tablet, a server, a supercomputer, a calculator, a music player, a smart watch and a telephone.

The term “input device” refers in this document to a device suitable for delivering an input to a computer by a person. This input is not limited to a certain modality and may comprise mechanical movement, sound, images and the like. The input may be discrete and/or continuous. The input is also not limited by the number of degrees of freedom. The input may concern both direct and indirect input. With the providing of input regarding a position or the change thereof, such as, for example, an indicator on a screen, the input may be both absolute and relative. A non-limitative list of examples of input devices includes a keyboard, a computer mouse, a touchpad, a touchscreen, a camera, a scanner, a joystick, a microphone, a light pen, a trackball, a projection keyboard and a games controller.

The term “values” refers in this document to the meaning as used in psychology. Schwartz and Bilsky define this term in the Journal of Personality and Social Psychology 58(5), 550-562 (1987): values are concepts or beliefs about desirable end states or behaviors that transcend specific situations, guide selection or evaluation of behaviour and events, and which are sorted according to relative importance. Examples of values are certainty, equality, peacefulness, self-development and maturity. Furthermore, we refer to the document by Schwartz and Bilsky, as well as the documents cited therein, for a non-limitative list of examples of values. A number of values are also discussed in example 1.

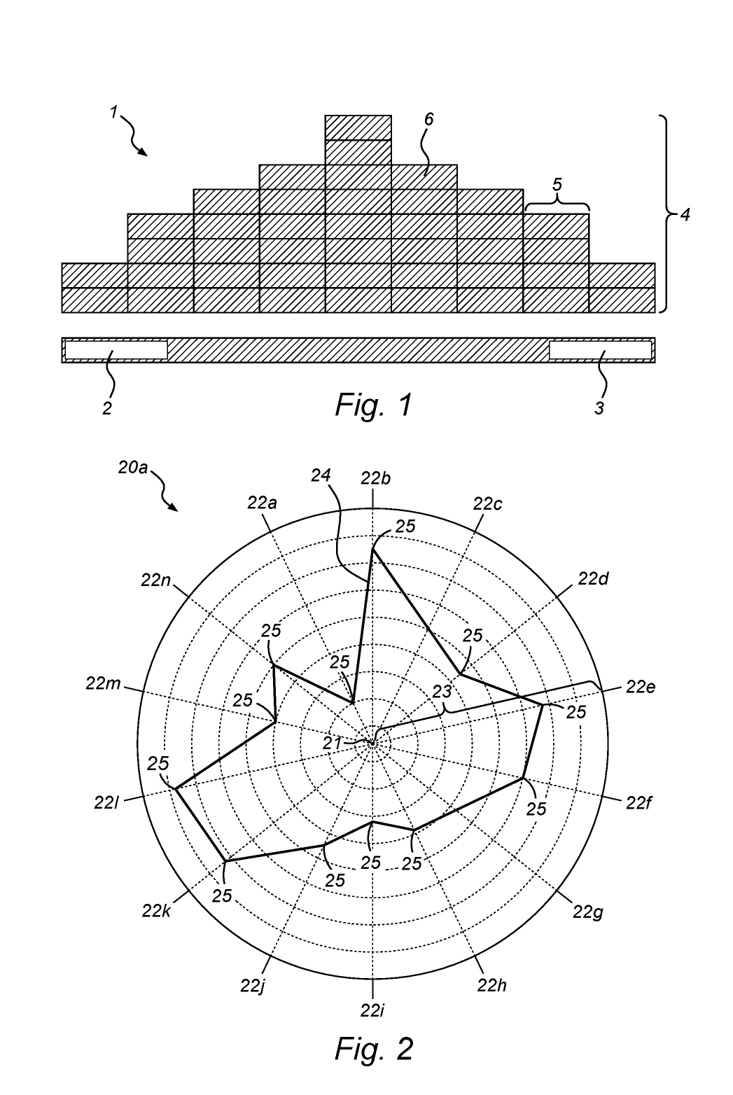

The term “ipsative Q-sort” refers in this document to the term as used in psychometric tests. It comprises a forced sorting of objects along an axis. To explain the term further, an example of an ipsative Q-sort is discussed in the following. The example is, however, only intended to illustrate the term “ipsative Q-sort” and not to limit this to the specific example or partial aspects thereof. In addition, the example includes a schematic representation of an ipsative Q-sort. This schematic representation must not in any way be interpreted as being limitative for the term “ipsative Q-sort”. In the context of this document, the objects to be sorted are statements. The axis indicates a ranking, e.g. of personal importance (e.g. “I do not find important at all” or “I find quite important”) or a degree of agreement (e.g. “completely agree”, “neutral” or “partly disagree”). In the context of this document, a position on the axis determines the score of a sorted object. Terms such as “I do not find important at all” or “neutral” are examples of scores. The value test comprises a numerical value for each score. A person who completes the value test can be informed of these numerical values. A person who completes the value test cannot be informed of these numerical values either. A schematic representation (1) of an example of an ipsative Q-sort is given in FIG. 1. The axis is indicated here by the lowest score (2), e.g. “least important”, as well as the highest score (3), e.g. “most important”. The specific example in FIG. 1 comprises locations, regions or association possibilities (6) for organising objects, i.e. statements. Each score comprises a column (5) with a number of locations. The total of columns (4) determines the distribution possibilities over the scores. In the example in FIG. 1, for example, two objects can be placed at the highest score and eight objects at the score corresponding to the centre column.

A “quantitative comparison” or the “quantitative comparing” of numerical values can include the direct comparing of these numerical values. These terms can also include the carrying out of calculations with said numerical values as an input, as well as the comparing of the calculated numerical values arising from this.

The citing of numerical intervals through the endpoints comprises all integers, fractions and/or real numbers between the endpoints, including these endpoints.

In a first aspect, the invention relates to a method for making a fit comparison of a candidate in a group. A value test is provided comprising a plurality of statements and a scoring system for associating a score with each statement. Each score comprises a numerical value. The “filling in of the value test” involves the association of a score with each statement of the value test. For taking the value test, at least one computer is provided comprising at least one processor, at least one screen and at least one input device. The candidate completes the value test on one of the computers by operating at least one of the input devices of this computer. Further, each reference person of a plurality of reference persons also completes the value test on one of the computers by operating at least one of the input devices of this computer. In this way, the numerical values of at least one score of the candidate can be compared quantitatively with the numerical values of at least one score of the plurality of reference persons. Preferably, the numerical values of all scores are compared quantitatively.

Each statement preferably comprises a position on at least one value. In an alternative embodiment, a statement can also comprise a position for gauging the candidate's personality. In that case, the test is a combined personality and value test.

A score can for example be a degree of agreement, such as “strongly agree”, “neutral” or “partly disagree”; a colour; a number; or any measure whatsoever for assessing a statement. Because a numerical value corresponds to each score, it is possible to carry out an objective numerical analysis for the quantitative comparison of value tests.

This is advantageous for various reasons. A uniform, objective value test is provided for both the candidate and the plurality of reference persons, e.g. the employees of an organisation, for the quantitative comparison of the value profile of the candidate with the value profile of the organisation. Because the value test is taken via a computer, the value test can be taken simultaneously by various people, and by a large number of people, e.g. by the employees of an organisation on their own work computer. When completing the test, the candidate and the reference persons are not influenced by the behaviour of an interviewer or by the methods used by an interviewer. Furthermore, completing the value test on a computer ensures that the data corresponding to a completed value test are immediately digitally available for further processing. No additional waiting time or action is required before the further processing can start.

In a preferred embodiment of the method, the scoring system comprises discrete scores. Each of the scores comprises a number of association possibilities. The total number of association possibilities of all scores of the scoring system is hereby equal to the total number of statements of the value test. The completion of the value test comprises the association according to a one-to-one relationship of a statement with an association possibility of a score. Then one association possibility of one score is associated with each statement, so that each association possibility of each score is associated with one statement.

In a further preferred embodiment of the method, this scoring system is an ipsative Q-sort.

These preferred embodiments are advantageous because the forced sorting of the statements on provided association possibilities of scores prevents the candidate or a reference person from giving socially desirable answers. In social terms, for example, collaborating and self-development are both important. If a score can be given to both values independently, a so-called normative scoring system, then it can happen that both values are given an equal, and typically positive, assessment. By forcing the candidate or a reference person to organize values, in what is known as an ipsative scoring system, a choice has to be made, for example, whether collaborating or self-development is more important. Research has shown that an ipsative scoring system produces more objective results.

In a further preferred embodiment, the ipsative Q-sort comprises a plurality of categories, wherein each category comprises a number of the discrete scores and the corresponding association possibilities. In the method, the statements are then first broken down into the categories, whereby each category is assigned a total number of statements with the corresponding association possibilities. Then the statements are organized over the scores by category.

This is advantageous because, with a plurality of discrete scores, it is not easy to organize all statements over the plurality of scores immediately. It can be easier to first break down the statements into a limited number of categories, to subsequently link the statements within a category to the association possibilities of the scores in the category.

In a preferred embodiment, the value test comprises at least one value group. Each value group comprises at least one statement of the value test. Most preferably, the value test comprises a plurality of value groups, and each statement belongs to one of the value groups. A value group score corresponds to each value group of a completed value test. The value group score is the mean of the numerical values of the scores that are associated with the statements of the value group in the completed value test. The value group score for the candidate and for each reference person is calculated for each value group. Then the value group score of the candidate is compared quantitatively with at least one value group score of the plurality of reference persons.

In this way, scores of statements with a similar theme can be grouped according to the theme. A value group may relate, for example, to such a theme or a “value” as used in psychology. A comparison can then be made by value group between the candidate and the plurality of reference persons, e.g. an organisation.

In one embodiment, for the quantitative comparison of the value group score of the candidate with at least one value group score of the plurality of reference persons, the candidate percentage for each value group is calculated. The candidate percentage is the percentage of reference persons with a value group score lower than the value group score of the candidate.

This is advantageous because the candidate percentages for each of the value groups form an objective and quantitative measure for comparing the value profile of a candidate with the value profile of the plurality of reference persons, e.g. the value profile of an organisation. In addition, the candidate percentage for each of the value groups can be calculated easily and quickly with the aid of at least one computer.

In a preferred embodiment of the method, a number of data persons are identified. Preferably, the plurality of reference persons comprises all data persons. In this respect, the data persons may, for example, be part of a business unit, a team or a branch of the organisation. The value test is also completed by each of the data persons by using at least one of the input devices of one of the computers. A person skilled in the field will appreciate that if the plurality of reference persons comprises a data person, this data person only completes the value test once. This data is then processed into the statistics of both the data persons and the plurality of reference persons. In this preferred embodiment, then the numerical values of at least one score of the candidate, at least one score of the plurality of reference persons and at least one score of the data persons are compared quantitatively. Preferably, the numerical values of all scores are compared.

In this preferred embodiment, it is intended to make a comparison in the value profiles of the candidate and the group of data persons. Here, not only the value profile of the candidate is compared with the value profile of the data persons, but both value profiles are also compared with the value profile of the plurality of reference persons, e.g. the whole organisation.

In a further preferred embodiment, the mean value group score of the data persons is determined for each value group. Then, the value group score of the candidate and the mean value group score of the data persons are compared quantitatively for each value group.

This is advantageous because it allows a direct comparison of the value profiles of a candidate and the data persons by value group, i.e. by similar theme.

In one embodiment, the mean value group score of the data persons for each value group is used to determine the data percentage for each value group. The data percentage is the percentage of reference persons with a value group score lower than the mean value group score of the group of data persons. Then the candidate percentage and the data percentage are compared quantitatively by value group.

This is advantageous because it allows the importance that the candidate attaches to a value group relatively in respect of the plurality of reference persons to be compared with the mean relative importance that the group of data persons attaches to this value group. Here, not only the value profile of the candidate and the group of data persons is compared, but also the relative importance in the plurality of reference persons, e.g. the employees of an organisation, is examined simultaneously. The plurality of reference persons may also relate to all persons who have ever completed the value test, and then, the data persons may be the employees of an organisation, a business unit of an organisation, a team of an organisation, a branch of an organisation or any subset of the plurality of reference persons.

In a preferred embodiment, the mean aᵢ and the standard deviation σᵢ of the numerical values corresponding to the scores of the data persons are calculated for each statement i of the value test. Then the numerical deviation dᵢ of the candidate to the group of data persons is calculated for each statement i of the value test from a function f on the basis of the numerical value tᵢ of the score of the candidate, the mean aᵢ and the standard deviation σᵢ: dᵢ=f(ti, ai, σᵢ).

This is advantageous because the calculation can be carried out quickly and easily. The calculation can be carried out with at least one computer. Moreover, for different candidates, the mean aᵢ and the standard deviation σᵢ only have to be calculated once for one and the same group of data persons. By taking into account the standard deviation σᵢ in addition to the mean aᵢ, the relative importance of a deviation of the numerical value tᵢ of the score of the candidate to the mean aᵢ can be weighted on the basis of the spread σᵢ within the group of data persons.

In a further preferred embodiment, this function f is the weighted normalized absolute difference

$$f ( x , {a}_{i} , {σ}_{i} > 0 ) = \frac{\vert x - {a}_{i} \vert}{{σ}_{i}^{p}} {\vert x \vert}^{q}$$

for positive standard deviations, i.e. for σᵢ>0, wherein p and q are non-negative powers. Preferably p=1 and 0≤q≤2 such as q is equal to 0, 0.5, 1, 1.5 or 2. Most preferably, p is equal to 1 and q is equal to 0.

In a further preferred embodiment, this function f is the weighted normalized absolute difference

$$f ( x , {a}_{i} , {σ}_{i} = 0 ) = \frac{\vert x - {a}_{i} \vert}{g ( N )} {\vert x \vert}^{q}$$

for standard deviations σᵢ equal to zero with N being the number of data persons. g(N) is in this case 1 if N=1 and

$$g ( N ) = \sqrt{\frac{1}{N - 1} [ ( N - 1 ) \frac{1}{{N}^{2}} + {( 1 - \frac{1}{N} )}^{2} ]}$$

for N greater than 1.

This is advantageous because the deviation of the numerical value tᵢ of the score of the candidate to the mean aᵢ is weighted with the spread σᵢ in the group of data persons. If the spread in the group of data persons for statement i is large, less importance is attached to the corresponding deviation of the candidate. Moreover, in the function f with a positive power q, more weight is associated to statements i that are important for the candidate, i.e. statements with a high candidate score tᵢ, which will ensure that for values to which the candidate attaches great importance, he or she will fit better with the group of data persons.

In a preferred embodiment, a comparison group is provided comprising at least one statement of the value test. Preferably, the comparison group comprises all statements of the value test. For each statement i of the comparison group and for each reference person r, the numerical deviation δ_{i,r}=f(v_{i,r}, aᵢ, σᵢ) is calculated, with v_{i,r} being the numerical value of the score of the reference person r associated with the statement i. For the candidate, the numerical deviations dᵢ are added up over the statements i of the comparison group, resulting in a numerical deviation D. For each reference person r, the numerical deviations δ_{i,r} are added up over the statements i of the comparison group, resulting in a numerical deviation Δᵣ. The percentage of reference persons r with a numerical deviation Δᵣ larger than the numerical deviation D is determined.

This is advantageous because with a single percentage it is quantified how well a candidate corresponds to the value profile of a group of data persons, relatively in relation to the plurality of reference persons. Moreover, the numerical deviations Δᵣ can be determined once beforehand for multiple different candidates.

In a preferred embodiment, the method also comprises adaptation steps for adapting the value test or the processing method for comparing value profiles. These adaptation steps involve the completion of a performance questionnaire for gauging for the performance level, i.e. the suitability and the well-being, of a plurality of persons in an organisation, a business unit, a team, or a branch. This performance questionnaire can gauge for the job satisfaction, the promotion, the bonuses, and (the intention of) the job progression of these persons. By adapting the value test and/or the calculation method for the quantitative comparison of value profiles, e.g. by adapting the powers p and/or q, as great a correlation as possible can be ensured between the performance level of a person and the agreement of value profiles between the person and his/her environment.

In a second aspect, the present invention relates to a computer program product for making a fit comparison of a candidate in a group by means of taking a value test with the aid of a computer. The computer comprises at least one processor, at least one screen and at least one input device. The value test comprises statements and an ipsative Q-sort for the association of a score with each statement. Each score comprises a numerical value. The computer program product comprises instructions for the display of at least one statement on at least one of the screens; the association of a score with a statement displayed on a screen by the processing of signals originating from at least one of the input devices; and the storage of a completed value test on a tangible non-transitory storage medium. The completed value test comprises data suitable for determining the numerical values corresponding to the inputted scores on each of the statements of the value test.

With the aid of this computer program product, the value test can be completed by at least one candidate and the plurality of reference persons.

In a preferred embodiment of the computer program product, the computer program product comprises instructions for the display of a region on at least one of the screens corresponding to a score. In addition, the computer program product comprises instructions for associating a score with a statement displayed on the screen by moving the statement displayed to the region on the screen corresponding to the score on the basis of signals originating from at least one of the input devices. Preferably, the signals are generated by operating a computer mouse, a touchpad or a touchscreen by a candidate or a reference person.

This is advantageous because it allows a user of the computer program product, with at least one input device, to organize the statements in a way that is visually perceptible. In this, a user maintains the overview of all the statements that are to be organized as well as the current order. With this, it becomes easier for a user to complete the value test.

In a further preferred embodiment, the computer program product comprises instructions for the sorting of statements over a plurality of categories according to a predetermined number of statements per category. In addition, the computer program product comprises instructions for the organizing of statements in a category over a number of association possibilities of the scores belonging to the category.

This is advantageous because with a plurality of discrete scores, it is not easy to organize all statements immediately over the plurality of scores. It can be easier to first distribute the statements over a limited number of categories, in order to then link the statements in a category to the association possibilities of the scores in the category.

In a preferred embodiment, the computer program product comprises instructions for sending over a network of at least one statement from a server comprising the tangible non-transitory storage medium to the computer. Preferably, the network comprises an Internet connection. In addition, the computer program product comprises instructions for sending data suitable for determining the numerical values corresponding to at least one associated score from the computer to the server over the network. In a further preferred embodiment, the computer program product can be suitable for the completion of the value test via a web browser.

This is advantageous because a completed value test (or the data suitable for determining the numerical values corresponding to the scores of the completed value test) can be stored on a central server for storage and/or further processing. Furthermore, for the completion of the value test via a web browser, the user of the computer program product does not have to install any software on his or her computer.

In a preferred embodiment, the computer program product comprises instructions for, storing data suitable for determining whether the value test has been completed by a candidate or a reference person together with the completed value test. Preferably, this data comprises a unique identification of the user, such as a label assigned to him/her or his/her name.

This is advantageous because it allows the value test to be completed by a plurality of reference persons, who later, depending on the position a candidate is applying for, may belong, or not, to the group of data persons. Furthermore, the storage of a unique identification with a completed value test is also advantageous for the removal of this value test when the corresponding reference person leaves the organisation, e.g. when he/she retires.

In a preferred embodiment, the computer program product comprises instructions for carrying out at least one of the processing steps for the processing and quantitative comparison of completed value tests according to the method of the first aspect of the present invention. In addition, the computer program product preferably comprises instructions for the visualisation of data suitable for the comparison of value profiles.

This is advantageous because one single computer program product can provide for the collection, storage, processing and visualisation of data related to completed value tests.

In a preferred embodiment, the value test comprises at least one value group and each value group comprises at least one statement of the value test. Most preferably, the value test comprises a plurality of value groups, and each statement belongs to one of the value groups. In addition, the computer program product comprises instructions for calculating a value group score for each of the value groups of a completed value test. The value group score is the mean of the numerical values associated with the statements of the value group. In addition, the computer program product contains instructions for the display of a graph comprising a visualisation of the value group score of the candidate for each of the value groups on a computer screen for the candidate.

In a preferred embodiment, the computer program product comprises instructions for calculating, for each of the value groups, a mean value group score of a group of data persons, and for a candidate to show a graph on a computer screen comprising a visualisation for each of the value groups of:
the value group score of the candidate; and
the mean value group score of the data persons.

In a preferred embodiment, the computer program product comprises instructions for calculating, for each of the value groups, a mean value group score of a group of data persons, and for a candidate to display on a computer screen a graph comprising for each of the value groups a visualisation of:
the percentage of reference persons with a value group score lower than the value group score of the candidate; and
the percentage of reference persons with a value group score lower than the mean value group score of the data persons.

In a preferred embodiment, the computer program product comprises instructions for calculating, for each statement i of the value test, the mean aᵢ and the standard deviation σᵢ of the numerical values corresponding to the scores of the data persons. Moreover, the computer program product comprises instructions for calculating, for each statement i of the value test, a numerical deviation dᵢ=f(tᵢ, aᵢ, σᵢ), with f being a function and tᵢ being the numerical value of the score of the candidate associated with statement i. Preferably, for a positive standard deviation σᵢ>0, this function f is the weighted normalized absolute difference

$$f ( x , {a}_{i} , {σ}_{i} > 0 ) = \frac{\vert x - {a}_{i} \vert}{{σ}_{i}^{p}} {\vert x \vert}^{q}$$

with p and q being non-negative powers, preferably with p equal to 1 and q at least 0 and at most 2 such as 0, 0.5, 1, 1.5 or 2, and most preferably with p equal to 1 and q equal to 0. In addition, the computer program product comprises instructions for calculating, for each statement i of the value test and for each reference person r, a numerical deviation δ_{i,r}=f(v_{i,r}, aᵢ, σᵢ), with v_{i,r} being the numerical value of the score of the reference person r associated with statement i. The computer program product also comprises instructions for adding up the numerical deviations dᵢ over the statements i of the value test, resulting in a numerical deviation D; adding up the numerical deviations δ_{i,r} over the statements i of the value test for each reference person r, resulting in a numerical deviation Δᵣ; determining the percentage of reference persons r with a numerical deviation Δᵣ greater than the numerical deviation D of the candidate; and displaying this percentage on the computer screen.

In a preferred embodiment, the method and the computer program product can also be extended for use in social media. For a person, a social medium includes a circle of acquaintances comprising e.g. friends, family and/or colleagues. The circle of acquaintances can also be characterised by the degree of contact, e.g. direct knowledge, one intermediary, two intermediaries, etc. In the present embodiment, the invention intends to determine the value profile of a person by extrapolation and/or interpolation of the value profiles of the circle of acquaintances. In this, the extrapolation and/or interpolation can take into account the intensity and the characteristics of the contact, such as e.g. professionalism, personality, frequency, tone, use of language, style, etc. In this, the extrapolation and/or interpolation can also take into account the degree of contact. The value profile obtained in this way is a probable or implicit value profile on the basis of probably shared values in the circle of acquaintances. In a further preferred embodiment, the system can be made self-learning by comparing the probable value profile on the basis of extrapolation and/or interpolation with the actual value profile on the basis of the value test. In this way, a set of parameters can be identified in order to minimise a difference standard of the probable and the actual value profile.

In what follows, the invention is described on the basis of non-limiting examples that illustrate the invention, and which are not intended to limit or should not be interpreted as limiting the scope of the invention.

### EXAMPLES

### Example 1: Values

In this example, 14 values are discussed. These can form the basis for subdividing the statements of a value test into value groups.

### Collaboration

People who score highly for collaboration prefer a working environment in which importance is attached to teamwork. When taking decisions or taking actions, they first consider the consequences for the team, and only then consider the effect on themselves. By sharing information and helping each other, they contribute to achieving the team's objectives. Efforts made for the team are of the utmost importance to them.

### Conformity

People who score highly for conformity prefer a working environment without conflicts. They avoid disputes, regardless if this is at the expense of their personal opinion. They want people to abide by the rules, and apart from that do what is necessary to keep the peace. Avoiding conflicts is of the utmost importance to them.

### Recognition

People who score highly for recognition prefer a working environment in which actions are noticed by others. They want the necessary respect for their contribution, and prefer to collaborate with people who respect their work. Being appreciated for what they do is of the utmost importance to them.

### Care

People who score highly for care prefer a working environment in which people help each other. They want others to feel good, and will do what is necessary to contribute to this. Be it managers, colleagues or clients, doing the right thing and helping others are of the utmost importance to them.

### Equality and Diversity

People who score highly for equality and diversity prefer a working environment in which origin, sex or other personal characteristics do not matter. They want everyone to be treated in the same way, for what people do, and not for who they are. A neutral, objective environment is of the utmost importance to them.

### Autonomy

People who score highly for autonomy prefer a working environment in which they can have an influence on their tasks. Within their formal range of duties, they like to steer what they have to do, or how they do it. They prefer to define their agenda themselves. Working autonomously is crucial to them.

### Power

People who score highly for power prefer a working environment in which they pull the strings. Preferably they steer the behaviour of others, so that they can determine themselves what happens. They are the ones calling the shots, all things revolve around their personal agenda.

### Predictability

People who score highly for predictability prefer an organized working environment. They like structure, and like to know what to expect. They prefer to do things they are used to doing. Structure and regularity are crucial to them.

### Performance

People who score highly for performance prefer a working environment in which their own achievements are recognised. They do everything possible to show the best of themselves. They prefer to perform tasks through which they can demonstrate their capabilities. Being able to excel is crucial to them.

### Self-Development

People who score highly for self-development prefer a working environment in which they can learn. They wish to expand their understanding of things in order to obtain a greater knowledge. Preferably, they can learn new things continuously. Personal development is crucial to them.

### Sustainability

People who score highly for sustainability prefer a working environment in which people think for the long term. They want to do a good job, taking all stakeholders into account. They uphold the values of man, safety and the environment, both for themselves and for all those involved in their work. Delivering quality is crucial to them.

### Integrity

People who score highly for integrity prefer a working environment in which people work with integrity. They do their work with care, and remain discrete about its content. They are honest and always assume responsibility for what they do. Conscientiousness is crucial to them.

### Innovation

People who score highly for innovation prefer a working environment in which people are not afraid of change. Change is embedded in their DNA, preferably they are always trying out new things. A change every now and then is positive for their performance, after all, they are always up for new experiences. Being challenged is crucial to them.

### Decisiveness

People who score highly for decisiveness prefer a working environment in which people anticipate. They do not linger at the sidelines, and if necessary take the initiative. They do what it takes to achieve what they want to achieve. Obtaining results is crucial to them.

### Example 2: Statements and Breakdown into Value Groups

In table 1, 42 statements are given as an example, as well as their breakdown into value groups according to the values of example 1.

TABLE 1
Breakdown of statements into value groups

| Value group | Statements |
|---|---|
| Collaboration | You often work with others |
| | The group's interests are more important |
| | than the interests of individuals |
| | You work hard for the team |
| Conformity | You don't give your opinion if this will lead |
| | to a conflict |
| | You do all you can to keep the peace |
| | You abide by the prevalent rules and |
| | standards |
| Recognition | You are respected by colleagues and |
| | managers |
| | You are recognised for what you do |
| | Your commitment is valued |
| Care | You do good for other people |
| | You contribute to other people's well-being |
| | You help colleagues, customers and/or other |
| | stakeholders |
| Equality & | Everyone gets equal opportunities |
| Diversity | It doesn't matter what your age, |
| | background or gender is |
| | People look at what you do, not at who you |
| | are |
| Autonomy | You have to a great extend the freedom to |
| | decide what you do |
| | You choose the way you work |
| | You plan your own activities |
| Power | I can influence other people's behaviour |
| | I am the one who decides what needs to be |
| | done |
| | I decide what happens |
| Predictability & | There is structure and regularity |
| tradition | Things usually goes to plan |
| | You can keep traditional values and ways of |
| | thinking |
| Performance | You can show just how good you are |
| | You can show what you are capable of |
| | You can excel in what you do |
| Autonomy | You can keep on learning new things |
| | You can increase your knowledge |
| | You can keep on developing yourself |
| | continuously |
| Sustainability | You deliver quality work |
| | You show respect for customers and/or |
| | other stakeholders |
| | You care about people, safety and the |
| | environment |
| Integrity | You take responsibility for what you do |
| | You are honest |
| | You are discrete with personal and |
| | confidential information |
| Innovation | You can try new things |
| | You can experience lots of new things |
| | You can find challenges |
| Decisiveness | You do work on your own initiative |
| | You make sure that results are achieved |
| | You do all you can to meet the targets set |

### Example 3

In this example, 42 statements are given about the ideal workplace:

In my ideal workplace . . .
. . . you often work with others
. . . the group is more important than one person
. . . you do your best for the team
. . . you don't give your opinion if this will lead to a disagreement
. . . you do all you can to prevent arguments
. . . you abide by the rules and standards
. . . you are respected by colleagues and managers
. . . you are recognised for what you do
. . . your commitment is valued
. . . you do good for other people
. . . you make sure that others feel good about themselves
. . . you help colleagues, customers and/or other parties
. . . everyone gets equal opportunities
. . . it doesn't matter what your age, background or gender is
. . . people look at what you do, not at who you are
. . . you have the freedom to decide what you do
. . . you choose the way you work
. . . you plan your own activities
. . . I can influence other people's behaviour
. . . I am the one who says what needs to be done
. . . I decide what happens
. . . there is structure and regularity
. . . things usually go according to plan
. . . you can keep traditional values and ways of thinking
. . . you can show just how good you are
. . . you can show what you are capable of
. . . you can excel at what you do
. . . you can keep on learning new things
. . . you can increase your knowledge
. . . you can keep on developing yourself
. . . you deliver quality work
. . . you show respect for customers and other parties
. . . you care about people, safety and the environment
. . . you take responsibility for what you do
. . . people are honest
. . . you are discreet with confidential information
. . . you can try new things
. . . you can experience lots of new things
. . . you can find new challenges
. . . you do work on your own initiative
. . . you make sure results are achieved
. . . you do all you can to meet targets

### Example 4: Ipsative Q-Sort

FIG. 1 is a schematic representation of a visualisation possibility of an ipsative Q-sort (1) for organizing 42 statements according to an axis. Here, the axis is indicated by the lowest score (2), e.g. “least important”, and the highest score (3), e.g. “most important”. The ipsative Q-sort comprises nine columns (5) of association possibilities (6) belonging to nine discrete scores. The total (4) of 42 association possibilities ensures a forced organisation of the 42 statements according to the axis.

To facilitate this organisation, a test person is first asked to break down the 42 statements into 3 categories:
“least important” with space for 11 statements;
“neutral” with space for 20 statements; and
“most important” with space for 11 statements.

Then it is asked to split up the statements in the category “least important” over the three columns on the left, the statements in the category “neutral” over the three centre columns, and the statements in the category “most important” over the three columns on the right. This considerably simplifies the ordering process for the test person.

Moreover, the organisation process for the test person can be simplified additionally by moving statements to the association possibilities in the schematic representation of the ipsative Q-sort by using at least one input device, e.g. a computer mouse, a touchpad or a touchscreen.

### Example 5: Individual Value Profile

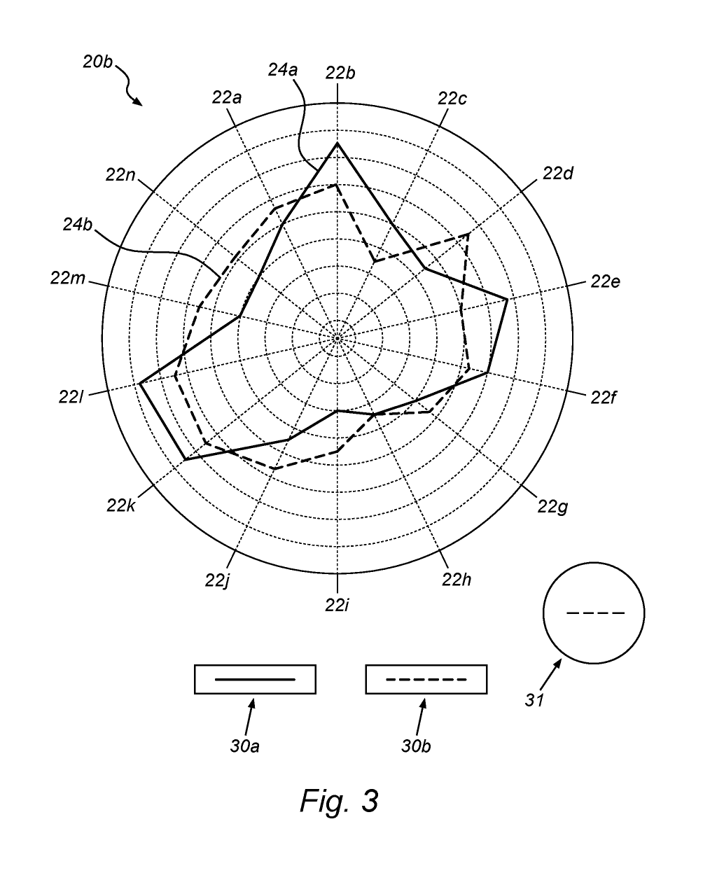

FIG. 2 comprises a graph (20a) with an example of an individual value profile of a candidate. It concerns a cobweb diagram. The various value groups (22a-22n) are indicated by name. A radial axis (23) corresponds to each value group for the visualisation of the value group score of the candidate. With value group 22a, the value group score is lower than with value group 22b. This is evident from the intersections (25) that the value profile (24a) of the candidate makes with the radial axes of the value groups. The further from the centre of the cobweb diagram, the greater the importance that the candidate attaches to this value group.

### Example 6: Comparison with a Group of Data Persons

FIG. 3 comprises a graph (20b) with the individual value profile (24a) of the candidate from example 5, as well as the value profile (24b) of a group of data persons. This group of data persons may, for example, be part of the same team, the same business unit or the same branch of the organisation. The group of data persons may, however, also include the direct future managers of a candidate. If the group of data persons includes future managers of a candidate, these persons can complete the value test according to their actual value profile or according to the desired value profile of an ideal candidate. In the graph, the mean value group score of the group of data persons is displayed for each of the value groups. In the specific example, it can be seen visually that the candidate attaches more importance to value group (22b) than the group of data persons. The grapc may also contain a legend (30a, 30b).

The percentage of reference persons r with an added up numerical deviation Δᵣ over the statements greater than the added up numerical deviation D of the candidate is displayed in a separate location (31). The higher this percentage, the better the candidate's profile fits with that of the group of data persons, compared with the plurality of reference persons.

### Example 7: Value Profile of a Group of Data Persons

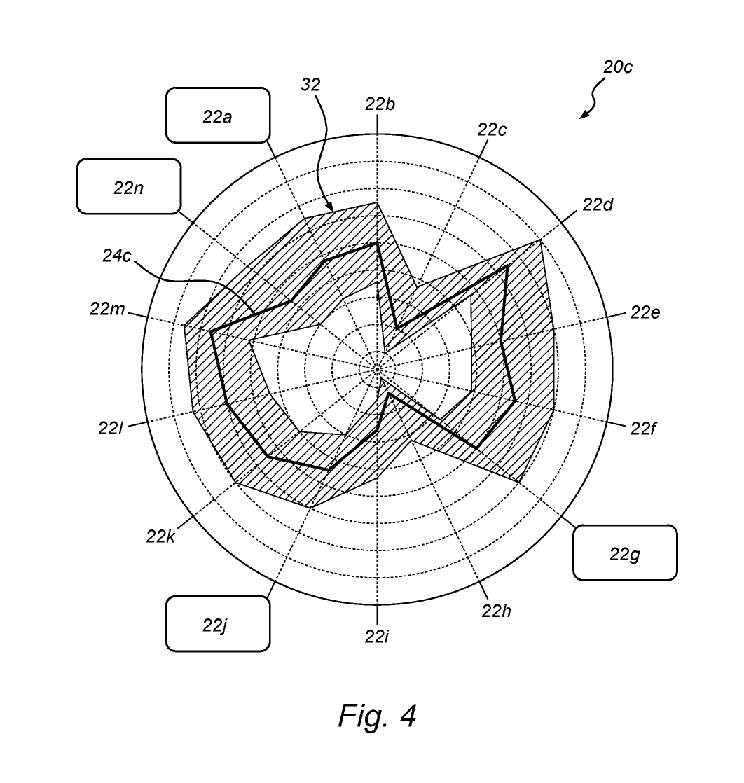

It can, however, also be useful to visualise not only the mean value group scores of a group of data persons, but also the spread. FIG. 4 comprises such a graph (20c). The mean values (24c) per value group as well as the values on the basis of one standard deviation (32) are visualised. For the latter, the mean value group score a_{g} as well as the spread σ_{g} are calculated for the group of data persons and for each value group g. The graph is then based on the value group scores a_{g}, a_{g}+σ_{g} and a_{g}−σ_{g}.

What is claimed is:

1. Method for making a fit comparison of a candidate in a group, the method comprising the steps of:
providing a value test, the value test comprising a plurality of statements and a scoring system for associating a score with each statement, wherein each score comprises a numerical value, and wherein completion of the value test comprises associating a score with each statement of the value test;
providing at least one computer comprising at least one processor, at least one screen and at least one input device; and
completing the value test by the candidate by operating at least one of the input devices of one of the computers,
wherein the method further comprises the following steps:
completing the value test by each reference person of a plurality of reference persons by operating at least one of the input devices of one of the computers; and
comparing quantitatively the numerical values of at least one score of the candidate with the numerical values of at least one score of the plurality of reference persons.

2. Method according to claim 1, wherein the scoring system comprises discrete scores, and wherein each of the scores comprises a number of association possibilities, and wherein the total number of association possibilities of the scoring system is equal to the total number of statements of the value test, and wherein the completion of the value test comprises associating each statement with one association possibility of one score so that each association possibility of each score is associated with one statement.

3. Method according to claim 2, wherein the scoring system comprises an ipsative Q-sort.

4. Method according to claim 1, wherein the value test comprises at least one value group comprising at least one statement of the value test, and wherein each value group of a completed value test comprises a value group score, wherein the value group score is the mean of the numerical values of the scores associated with the statements of the value group, the method comprising for each value group the steps of:
calculating the value group score of the candidate;
calculating for each reference person the value group score of the reference person; and
comparing quantitatively the value group score of the candidate with at least one value group score of the plurality of reference persons.

5. Method according to claim 4, wherein the method further comprises the following steps:
identifying a number of data persons; and
completing the value test by each data person by operating at least one of the input devices of one of the computers,
and wherein the method comprises for each value group the following steps:
determining the mean value group score of the data persons;
comparing quantitatively the value group score of the candidate with the mean value group score of the data persons; and
optionally:
determining the candidate percentage, whereby the candidate percentage is the percentage of reference persons with a value group score lower than the value group score of the candidate;
determining the data percentage, whereby the data percentage is the percentage of reference persons with a value group score lower than the mean value group score of the group of data persons; and
comparing quantitatively the candidate percentage with the data percentage.

6. Method according to claim 1, wherein the method further comprises the following steps:
identifying a number of data persons;
completing the value test by each data person by operating at least one of the input devices of one of the computers; and
comparing quantitatively the numerical values of at least one score of the candidate, at least one score of the plurality of reference persons and at least one score of the data persons.

7. Method according to claim 6, wherein the method comprises the following steps:
calculating, for each statement i of the value test, the mean aᵢ and the standard deviation σᵢ of the numerical values corresponding to the scores of the data persons; and
calculating, for each statement i of the value test, a function f of the numerical value tᵢ of the score of the candidate, the mean aᵢ and the standard deviation σᵢ, resulting in a numerical deviation dᵢ=f(tᵢ, aᵢ, σᵢ).

8. Method according to claim 7, wherein for each statement i for which the standard deviation σᵢ is positive, the function f is the weighted normalized absolute difference
$$f ( x , {a}_{i} , {σ}_{i} > 0 ) = \frac{\vert x - {a}_{i} \vert}{{σ}_{i}^{p}} {\vert x \vert}^{q}$$
with p and q non-negative powers.

9. Method according to claim 8, wherein p is equal to 1 and q equal to 0.

10. Method according to claim 7, wherein the method comprises the following steps:
providing a comparison group comprising at least one statement of the value test;
calculating, for each statement i of the comparison group and for each reference person r, the function f(v_{i,r}, aᵢ, σᵢ), with v_{i,r} being the numerical value of the score of the reference person r associated with the statement i, resulting in a numerical deviation δ_{i,r}=(v_{i,r}, aᵢ, σᵢ);
adding up the numerical deviations dᵢ over the statements i of the comparison group, resulting in a numerical deviation D;
adding up, for each reference person r, the numerical deviations δ_{i,r} over the statements i of the comparison group, resulting in a numerical deviation Δᵣ; and
determining the percentage of reference persons r with a numerical deviation Δᵣ greater than the numerical deviation D of the candidate.

11. Method according to claim 10, wherein the comparison group comprises all statements of the value test.

12. Computer program product for making a fit comparison of a candidate in a group by means of administering a value test with the aid of a computer, wherein the computer comprises at least one processor, at least one screen and at least one input device, and wherein the value test comprises a plurality of statements and a scoring system for associating a score with each statement, and wherein each score comprises a numerical value, the computer program product comprising instructions for:
displaying at least one statement on at least one of the screens;
associating a score with a statement displayed on a screen by the processing of signals originating from at least one of the input devices; and
storing a completed value test on a tangible non-transitory storage medium, the stored completed value test comprising data suitable for determining the numerical values corresponding to the inputted scores with each of the statements of the value test,
wherein the scoring system comprises an ipsative Q-sort.

13. Computer program product according to claim 12, wherein the computer program product comprises instructions for:
displaying a region on at least one of the screens corresponding to a score; and
associating a score with a statement displayed on the screen by moving the displayed statement to the region on the screen corresponding to the score on the basis of signals originating from at least one of the input devices.

14. Computer program product according to claim 12, wherein the computer program product comprises instructions for:
sending at least one statement from a server comprising the tangible non-transitory storage medium to the computer over a network; and
sending data suitable for the determination of the numerical values corresponding to at least one associated score from the computer to the server over the network.

15. Computer program product according to claim 14, wherein the network comprises an Internet connection.

16. Computer program product according to claim 12, wherein the value test comprises at least one value group, wherein each value group comprises at least one statement of the value test, the computer program product comprising instructions for:
taking the value test by a plurality of persons, whereby each person of the plurality of persons is a candidate or a reference person;
storing, together with a completed value test, data suitable for determining whether the value test has been completed by a candidate or a reference person;
calculating, for each value group of a completed value test, the mean of the numerical values of the scores associated with the statements of the value group, resulting in a value group score for each value group; and
displaying on a computer screen of a graph for a candidate comprising for each of the value groups a visualisation of the value group score of the candidate.

17. Computer program product according to claim 16, wherein a reference person may also be a data person and whereby the computer program product comprises instructions for:
storing, together with a completed value test, data suitable for determining whether the value test has been completed by a data person;
calculating, for each of the value groups, a mean value group score of the data persons;
displaying on the computer screen of a graph for a candidate comprising for each of the value groups a visualisation of:
the value group score of the candidate; and
the mean value group score of the data persons, and
optionally, displaying on the computer screen of a graph for a candidate comprising for each of the value groups a visualisation of:
the percentage of reference persons with a value group score lower than the value group score of the candidate; and
the percentage of reference persons with a value group score lower than the mean value group score of the data persons.

18. Computer program product according to claim 17, wherein the computer program product comprises instructions for:
calculating, for each statement i of the value test, the mean aᵢ and the standard deviation σᵢ of the numerical values corresponding to the scores of the data persons;
calculating, for each statement i of the value test, a numerical deviation dᵢ=f(tᵢ, aᵢ, σᵢ), with f being a function and tᵢ being the numerical value of the score of the candidate associated with statement i;
calculating, for each statement i of the value test and for each reference person r, a numerical deviation δ_{i,r}=f(v_{i,r}, aᵢ, σᵢ), with f being the function and v_{i,r} being the numerical value of the score of the reference person r associated with statement i;
adding up the numerical deviations dᵢ over the statements i of the value test, resulting in a numerical deviation D;
adding up for each reference person r of the numerical deviations δ_{i,r} over the statements i of the value test, resulting in a numerical deviation Δᵣ;
determining the percentage of reference persons r with a numerical deviation Δᵣ greater than the numerical deviation D of the candidate; and
displaying said percentage on the computer screen.

19. Computer program product according to claim 18, wherein for a positive standard deviation σᵢ the function f is the weighted normalized absolute difference
$$f ( x , {a}_{i} , {σ}_{i} > 0 ) = \frac{\vert x - {a}_{i} \vert}{{σ}_{i}^{p}} {\vert x \vert}^{q}$$
with p and q non-negative powers.

20. Computer program product according to claim 19, wherein p is equal to 1 and q is equal to 0.
